(19) United States
(12) Patent Application Publication
(10) Pub. No.: US 2025/0347407 A1
(43) Pub. Date: Nov. 13, 2025

(54) White Cane Capable of Emitting Light Throughout Its Body

(71) Applicant: Suzhou Xinxinlian Intelligent Technology Co., Ltd., Kunshan City (CN)

(72) Inventors: Yancheng Li, Kunshan City (CN); Sihao Chen, Kunshan City (CN); Jingjing Xu, Kunshan City (CN); Jianyuan Sun, Kunshan City (CN); Guanshi Chen, Kunshan City (CN); Shengyong Xu, Kunshan City (CN)

(21) Appl. No.: 18/914,401

(22) Filed: Oct. 14, 2024

(30) Foreign Application Priority Data
May 9, 2024 (CN) 202410568584.6

(51) Int. Cl. F21V 33/00; A61H 3/06; F21L 4/02; F21V 23/00; F21V 23/04; F21W 111/10; F21Y 103/10; F21Y 113/17; F21Y 115/10; H04R 1/02

(52) U.S. Cl. CPC F21V 33/0068; A61H 3/068; F21L 4/027; F21V 23/008; F21V 23/0407; F21V 23/0421; H04R 1/028; F21W 2111/10; F21Y 2103/10; F21Y 2113/17; F21Y 2115/10; H04R 2499/11

(57) ABSTRACT

A white cane capable of emitting light throughout its body is provided. The white cane comprises a white cane main body, a warning assembly, a control module and a battery. A whole cane body of the white cane can emit light, and auditory prompts can be passed to others with a loudspeaker, so that visibility of a blind user for others is obviously improved, and then traveling safety of blind people is greatly improved. A light strip of the white cane can emit various colors of light, and applicability is balanced during day and night, so that blind people can travel out all the day comfortably.

### CROSS-REFERENCE TO RELATED APPLICATION

This patent application claims the benefit and priority of Chinese Patent Application No. 202410568584.6 filed with the China National Intellectual Property Administration on May 9, 2024, the disclosure of which is incorporated by reference herein in its entirety as part of the present application.

### TECHNICAL FIELD

The present disclosure relates to a white cane capable of emitting light throughout its body, and belongs to the technical field of auxiliary tools for helping blind people to walk.

### BACKGROUND

Blindness and visual impairment are serious social and public health problems in the world, and there are a large number of visually impaired people in the world. At present, there are nearly 45 million blind people in the world and 135 million people with visual impairment. China is one of the countries with the largest number of blind people in the world, with 6-7 million blind people, accounting for 18% of the total number of blind people in the world. In addition, there are 12 million patients with binocular low vision.

The information obtained by normal people through vision accounts for 70%-80% of total information, and the dark world largely limits blind people's access to information. At present, the main tools to assist blind people when traveling out daily are guide dogs and white canes. The guide dog is high in training cost, needs daily consumption, has a limited life span, and is free of the possibility of widespread promotion. The white cane can help blind people sense the environment when traveling out to complete tasks such as detecting obstacles and assisting in going up and down stairs.

However, most of the existing white canes only focus on the purpose of sensing the environment, and do not consider catching attention from others to ask for help or warning others to avoid. Aiming at this problem, the Chinese patent 201220737864.8 designs a white cane with a roller capable of emitting light to remind others of avoiding the blind people. However, the white cane has a disadvantage that the white cane is not obvious since light is emitted at the handle or the roller, and also cannot play a role in the scene of asking others for help.

Therefore, it is necessary to invent a novel white cane capable of emitting light throughout the body so as to solve the above-mentioned problem.

### SUMMARY

An objective of present disclosure is to provide a white cane capable of emitting light throughout its body. The white cane can remind pedestrians and drivers to actively avoid during day and night through a cane body capable of emitting light. At the same time, it can also feed back current light-emitting state to a blind user through the loudspeaker and play specific audios for others to ask for help. In this case, traveling safety of blind people is greatly improved.

To achieve the above purpose, the present disclosure provides the following technical scheme.

A white cane capable of emitting light throughout the body, includes:
a white cane main body including a handle, a cane body and a cane tip which are connected in sequence;
a warning assembly including a light-emitting light strip arranged in the cane body, and a loudspeaker arranged in the handle;
a control module including a main control chip arranged in the handle, and a plurality of control buttons arranged on the handle and electrically connected with the main control chip, the light-emitting light strip and the loudspeaker are electrically connected with the control chip, respectively, and light-emitting status of the light-emitting light strip and playing status of the loudspeaker are controlled through the control module; and
a battery arranged in the handle, the battery is electrically connected with the main control chip, the light-emitting light strip and the loudspeaker, respectively.

Further, the cane body is made of transparent materials, the light-emitting light strip is installed and placed in the cane body, the light-emitting light strip includes several LED (Light Emitting Diode) lamp beads, and emitting colors of the LED lamp beads include red, green and blue.

Further, light-emitting modes of the light-emitting light strip include a normally on mode and a flicker mode.

Further, the loudspeaker is installed and placed in the handle, upper sound holes are formed in a top wall of the handle, side sound holes are formed in a side wall of the handle, and the loudspeaker can play various audios including a plurality of cue tones related to working condition of the white cane and a warning sound specifically designed for blind people.

Further, the white cane main body also includes a wrist strap arranged on the handle and fixedly connected with the handle.

Further, when the light-emitting status of the light-emitting light strip changes, the loudspeaker can emit corresponding cue tones.

Further, power of the battery is available for the light-emitting light strip to continuously emit light for more than 3 h.

Further, the cane body is detachably connected with the handle and the cane tip, respectively.

The present disclosure has the following beneficial effects.

A whole cane body of the white cane according to the present disclosure can emit light, and auditory prompts can be passed to others with a loudspeaker, so that visibility of a blind user for others is obviously improved, and then traveling safety of blind people is greatly improved. A light strip of in the white cane according to the present disclosure can emit various colors of light, and applicability is balanced during day and night, so that blind people can travel out all the day comfortably.

The above-mentioned description is merely an overview of the technical scheme of the present disclosure, and may be implemented in accordance with the contents of the specification in order that the technical means of the present disclosure can be more clearly understood. The following detailed description is taken in conjunction with preferred embodiments in conjunction with the attached figures.

### BRIEF DESCRIPTION OF THE DRAWINGS

To describe the technical schemes in the embodiments of the present discourse more clearly, the following briefly describes the attached figures required for describing the embodiments. Apparently, the attached figures in the following descriptions show merely some embodiments of the present disclosure, and a person of ordinary skill in the art may derive other drawings from these attached figures without creative efforts.

FIG. 1 is an integral structural schematic diagram of a white cane capable of emitting light throughout its body according to the present disclosure.

FIG. 2 is a structural schematic diagram of a control module of a white cane capable of emitting light throughout its body according to the present disclosure.

Reference signs of components in attached figures:
1, handle; 2, cane body; 3, cane tip; 4, light-emitting light strip; 5, control module; 6, wrist strap; 7, loudspeaker; 11, upper sound hole; 12, side sound hole; 51, control button; 52, main control chip; 53, battery.

### DETAILED DESCRIPTION OF THE EMBODIMENTS

The description of specific embodiments in the present disclosure is further described in conjunction with the following attached figures and embodiments. The following embodiments are used for illustrating the present disclosure, but are not used for restricting the scope of the present disclosure.

In the description of the present disclosure, it needs to be illustrated that the indicative direction or position relations of terms such as “center”, “top”, “bottom”, “left”, “right”, “vertical”, “horizontal”, “inside” and “outside” are direction or position relations illustrated based on the attached figures, just for facilitating the description of the present disclosure and simplifying the description, but not for indicating or hinting that the indicated device or element must be in a specific direction and is constructed and operated in the specific direction, the terms cannot be understood as the restriction of the present disclosure. Moreover, terms such as “first”, “second” and “third” are just used for distinguishing the description, but cannot be understood to indicate or hint relative importance.

In the description of the present disclosure, it needs to be illustrated that, except as otherwise noted, terms such as “install”, “link” and “connect” should be generally understood, for example, the components can be fixedly connected, and also can be detachably connected or integrally connected; the components can be mechanically connected, and also can be electrically connected; the components can be directly connected and also can be indirectly connected through an intermediate, and two components can be communicated internally. For those skilled in the art, the specific meanings of the terms in the present disclosure can be understood according to specific conditions.

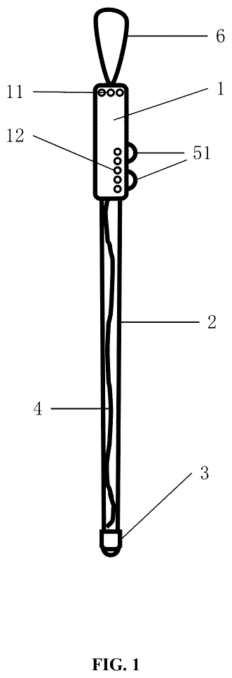

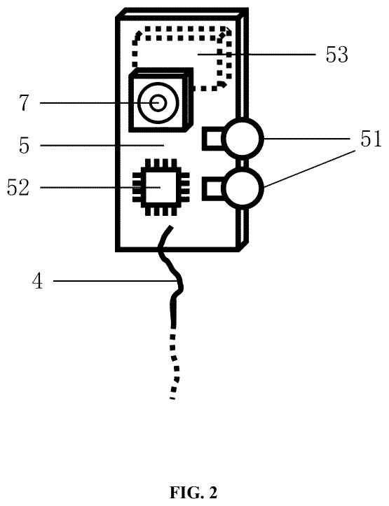

Referring to FIG. 1 and FIG. 2, a white cane capable of emitting light throughout its body in an embodiment of the present disclosure is provided. The white cane provides convenience for blind people when traveling out. The white cane can remind pedestrians and drivers to actively avoid during day and night through a cane body capable of emitting light, and can feed back a current light-emitting state to a blind user through the loudspeaker and play specific audios for others to ask for help, so that the traveling safety of blind people is greatly improved. The structure includes a white cane main body, a warning assembly, a control module 5 and a battery 53.

The white cane main body includes a handle 1, a cane body 2 and a cane tip 3 connected in sequence, and a wrist strap 6 arranged on the handle 1 and fixedly connected with the handle 1. The cane body 2 is made of transparent materials. The cane body 2 and the handle 1 are hollow structures. The cane body 2 is detachably connected with the handle 1 and the cane body 3, respectively. Different lengths of cane bodies 2 can be selected according to height of the blind user, and different styles of cane tips 3 can also be replaced according to road conditions. Meanwhile, after the cane tip 3 is worn out due to long-term use of the white cane, a new cane tip 3 is replaced without changing the whole white cane, so that service life of the white cane is prolonged, and using cost is reduced. The wrist strap 6 can sleeve the wrist of the blind user to prevent the white cane from falling off from the hand.

The warning assembly includes a light-emitting light strip 4 arranged on the cane body 2 and a loudspeaker 7 arranged on handle 1. Specifically, the light-emitting light strip 4 is installed and placed in the cane body 2, the light-emitting light strip 4 includes a plurality of LED lamp beads, and emitting colors of the LED lamp beads include red, green and blue. The LED lamp beads can emit light in corresponding proportions, and various colors of light is formed after the colors are mixed. As mentioned above, the cane body 2 is made of transparent materials. The cane body 2 is fitted with the light-emitting light strip 4. The whole cane body 2 can emit various colors of light, and applicability is balanced during day and night, so that the warning effect is obvious, and blind people can travel out all the day comfortably. Light-emitting modes of the light-emitting light strip 4 include a normally on mode and a flicker mode according to set patterns.

The loudspeaker 7 is placed in the handle 1, upper sound holes 11 are formed in a top wall of the handle 1, side sound holes 12 are formed in a side wall of the handle 1, and the loudspeaker 7 can play various audios such as a plurality of cue tones related to working condition of the white cane and a warning sound specifically designed for blind people.

The control module 5 includes a main control chip 52 arranged in the handle 1, and a plurality of control buttons 51 arranged on the handle 1 and electrically connected with the main control chip 52. The light-emitting light strip 4 and the loudspeaker 7 are electrically connected with the control chip, respectively. Light-emitting status of the light-emitting light strip 4 and playing status of the loudspeaker 7 are controlled through the control module 5. The blind user changes the light-emitting mode of the light-emitting light strip 4 through pressing the control button 51 corresponding to the light-emitting light strip 4. When the light-emitting status of the light-emitting light strip 4 is changed, the loudspeaker 7 can emit corresponding cue tones to be passed to the blind user through the upper sound holes 11, so that the light-emitting status of the light-emitting light strip 4 is controlled by the blind user conveniently. Further, the blind user can press the control button 51 corresponding to the loudspeaker 7, so that the loudspeaker 7 emits the warning sound specifically designed for blind people. The warning sound is passed to the surroundings through the side sound holes 12 to catch attention from others to ask for help or warn others.

The battery 53 is arranged in the handle 1. The battery 53 is electrically connected with the main control chip 52, the light-emitting light strip 4 and the loudspeaker 7, respectively, and is used for providing power for the light-emitting light strip 4, the loudspeaker 7 and the control module 5. The power of the battery 53 is available for the light-emitting light strip 4 to continuously emit light for more than 3 h so as to guarantee long-time outdoor activities for blind people.

In conclusion, the whole cane body of the white cane according to the present disclosure can emit light, and auditory prompts can be passed to others with a loudspeaker, so that visibility of the blind user for others is obviously improved, and then traveling safety of blind people is greatly improved. A light strip of the white cane according to the present disclosure can emit various colors of light, and the applicability is balanced during day and night, so that blind people can travel out all the day comfortably.

The technical features of the above-mentioned embodiments may be arbitrarily combined, and all possible combinations of the technical features in the above-mentioned embodiments are not described for simplicity of description. However, as long as the combinations of the technical features do not contradict one another, the technical features should be considered to be within the scope of the description of the present disclosure.

The above embodiments only express several embodiments of the present disclosure, and the description is specific and detailed, but cannot be construed as limiting the claims of the present disclosure. It should be noted that several modifications and improvements may also be made to those skilled in the art without departing from the inventive concept, which fall within the scope of the present disclosure. Therefore, the protection scope of the present disclosure shall be subject to the protection scope of the claims.

1. A white cane capable of emitting light throughout its body, comprising:
a white cane main body comprising a handle, a cane body, and a cane tip connected in sequence;
a warning assembly comprising a light-emitting light strip arranged in the cane body and a loudspeaker arranged in the handle;
a control module comprising a main control chip arranged in the handle, and several control buttons arranged on the handle and electrically connected with the main control chip, wherein the light-emitting light strip and the loudspeaker are electrically connected with the main control chip, respectively, and a light-emitting status of the light-emitting light strip and playing status of the loudspeaker are controlled through the control module; and
a battery arranged in the handle, the battery is electrically connected with the main control chip, the light-emitting light strip, and the loudspeaker, respectively;
upper sound holes formed in a top wall of the handle and side sound holes formed in a side wall of the handle;
wherein the upper sound holes are configured to emit cue tones from the loudspeaker to pass through to a blind user when the blind user presses a control button corresponding to the light-emitting light strip to cause the light-emitting status of the light-emitting strip to change, and
wherein the side second holes are configured to emit a warning sound from the loudspeaker when the blind user presses a control button corresponding to the loudspeaker to cause the loudspeaker to emit a warning sound to the surroundings to ask for help or to warn others.

2. The white cane capable of emitting light throughout its body according to claim 1, wherein the cane body is made of transparent materials, the light-emitting light strip is installed and placed in the cane body, the light-emitting light strip comprises several LED lamp beads, and emitting colors of the LED lamp beads comprise red, green and blue.

3. The white cane capable of emitting light throughout the body according to claim 2, wherein light-emitting modes of the light-emitting light strip comprise a normally on mode and a flicker mode.

4. (canceled)

5. The white cane capable of emitting light throughout its body according to claim 1, wherein the white cane main body further comprises a wrist strap arranged on the handle and fixedly connected with the handle.

6. The white cane capable of emitting light throughout its body according to claim 1, wherein when the light-emitting status of the light-emitting light strip changes, the loudspeaker is able to emit corresponding cue tones.

7. The white cane capable of emitting light throughout its body according to claim 1, wherein power of the battery is available for the light-emitting light strip to continuously emit light for more than 3 hours.

8. The white cane capable of emitting light throughout its body according to claim 1, wherein the cane body is detachably connected with the handle and the cane tip, respectively.
